(19) United States
(12) Patent Application Publication
(10) Pub. No.: US 2008/0278589 A1
(43) Pub. Date: Nov. 13, 2008

(54) Methods for identifying a target subject to automatically focus a digital camera and related systems, and computer program products

(76) Inventor: Karl Ola Thorn, Lund (SE)

Correspondence Address: MYERS BIGEL SIBLEY & SAJOVEC, P.A., P.O. BOX 37428, RALEIGH, NC, 27627, US

(21) Appl. No.: 11/801,837

(22) Filed: May 11, 2007

(51) Int. Cl. G03B 13/36

(52) U.S. Cl. 348/208.14; 348/208.12; 348/208.99; 348/E09.002

(57) ABSTRACT

Methods, devices and computer program products for identifying a target subject for auto-focusing a digital camera include selecting a target subject at a first position in a first image and identifying the target subject on a display. The target subject is identified at a second position in a second image based on the first image. A digital camera lens is automatically focused on the target subject at the second position.

### FIELD OF THE INVENTION

The present invention generally relates to digital camera devices, and may be particularly suitable for mobile electronic devices that include a digital camera.

### BACKGROUND OF THE INVENTION

Many digital still image and video cameras employ a passive type auto-focus system that measures the contrast of image content. Generally described, when comparing a sharp image with a blurred image, rendered on the same scene, the sharp image contains more information from high spatial frequencies. There are more transitions between dark and bright areas and the difference between the dark and bright areas is greater. Assessing the contrast of image content between images can give a relative measure of sharpness. A conventional contrast-based auto-focus system includes a camera lens, a focusing means for changing the position of the lens, an imaging sensor and a digital signal processor (DSP). The lens is configured to move to different discrete focusing positions, each corresponding to a particular subject-to-camera distance. In operation, the system moves the lens to a number of different positions during the auto-focusing process. An image is captured at each position and a relative sharpness value can be determined for each image. The system then moves the lens to the position that produced the image having the greatest sharpness value.

A typical mobile phone digital camera uses the image contrast technique for auto-focusing. The mobile phone camera may cover a focusing distance of from about 10 cm to infinity by using a resolution accomplished by between 10-20 focusing steps. Such a mobile phone camera may have a 2 million pixel sensor and a fixed focal length lens with an aperture f1:2.8. This type of camera may produce about 15-30 images every second in daylight or bright artificial light. Sub-sampling can be used to shorten this time for focusing images. In the sub-sampling method, the lens does not move to every discrete location during the search process. The sharpness values can be interpolated to produce an estimation of sharpness for the positions between those actually sampled. While sub-sampling may shorten the auto-focus time, a degradation in precision may be introduced. Some relatively sophisticated and precise (relatively expensive) video systems may address this problem by “hunting” the lens back and forth in very small steps.

An active auto-focusing system typically includes an infrared emitter and sensor which uses an infrared signal to determine the distance between the camera into the subject. An infrared pulse of light from the infrared emitter is reflected off of the subject. Various techniques can be used to determine the distance to the subject based on the reflected light detected by the sensor, including triangulation techniques, measuring the amount of infrared light reflected from the subject, and/or measuring the amount of time it takes for the reflected light to be sensed by the infrared sensor of the camera. Active auto-focus systems using infrared signals are generally effective when the subject is within about 20 feet (6 m) of the camera. One advantage of an active auto-focus system is that it can work in the dark, which may be particularly suited for flash photography.

Both active and passive auto-focusing systems typically focus on a region in the center of a focus frame. In other words, the region in the center of the focus frame will be more in focus than regions along the periphery of the focus frame. Auto focusing becomes difficult if the subject is not in the center of the focus frame or if the subject is moving.

In some cases, the photographer/user can place the subject in the center of the viewfinder or focus frame to focus the camera at a distant such that the subject is in focus. The user can subsequently move the camera so that the subject is not in the center of the viewfinder or focus frame when the picture is taken without refocusing. As a result, the subject is in focus even though the subject is not in the center of the captured image. However, this technique may be difficult or impossible to apply when a subject is moving rapidly and/or changes distances with respect to the camera. This technique also relies on the user to accurately control the auto-focus function and may introduce operator errors and/or inaccuracies when the subject is moved to the periphery of the viewfinder or focus frame.

### SUMMARY

According to some embodiments of the present invention, methods, devices and computer program products for identifying a target subject for auto-focusing a digital camera include selecting a target subject at a first position in a first image and identifying the target subject on a display. The target subject is identified at a second position in a second image based on the first image. A digital camera lens is automatically focused on the target subject at the second position.

In some embodiments, identifying the target subject on the display includes detecting color and/or break this contrast around the target subject to define a region including the target subject. The region including the target subject can be visually indicated on the display.

In some embodiments, the target subject can be identified at the second position in the second image by tracking movement of the target subject between the first and second positions and/or identifying at least one feature of the target subject in the second image based on the first image.

In some embodiments, a region including the target subject is visually indicated on the second image on the display.

In some embodiments, automatically focusing the digital camera lens on the target subject at the second position includes passively a focusing the digital camera lens based on image sharpness of the region including the target subject at the second position using at least two different focusing positions of the digital camera lens.

In some embodiments, automatically focusing a digital camera lens on the target subject at the second position includes actively automatically focusing a region in the second image that includes the target subject. In particular embodiments, a direction of the target subject can be determined with respect to the digital camera, and an active automatically focusing been can be aimed in the direction of the target subject. A reflection of the automatic focusing beam can be detected, and a distance between the digital camera and the target subject can be determined. The active automatic focusing been can be an infrared signal.

In some embodiments, the selection of the target subject can be reset to a different target subject.

### BRIEF DESCRIPTION OF THE DRAWINGS

FIG. 1 is a flowchart illustrating operations according to embodiments of the present invention;

FIG. 2 is a schematic drawing of a focus frame, such as a focus frame that can be viewed on a display of a digital camera according to embodiments of the present invention;

FIG. 3 is a digital image of a focus frame with an identified target subject therein according to embodiments of the present invention;

FIG. 4A is a focus frame displaying digital image with a subject in a center region thereof according to embodiments of the present invention;

FIG. 4B is the focus frame of FIG. 4A with the target subject visually indicated by outlining the target subject according to embodiments of the present invention;

FIG. 4C is the focus frame of FIG. 4A illustrating an image in which the target subject is at another different position with respect to the focus frame/camera position according to embodiments of the present invention;

FIG. 4D is the focus frame of FIG. 4A illustrating an image captured with the camera lens focused on the target subject according to embodiments of the present invention;

FIG. 5A is another focus frame displaying a digital image with one target subject visually indicated with an outline according to embodiments of the present invention;

FIG. 5B is the focus frame of FIG. 5A displaying another digital image that allows the user to reset the focus frame to a different target subject, which is visually indicated with an outline according to embodiments of the present invention;

FIG. 6 is a block diagram indicating methods systems and computer program products according to embodiments of the present invention; and

FIG. 7 is a block diagram of a mobile terminal including a camera according to embodiments of the present invention.

### DETAILED DESCRIPTION OF EMBODIMENTS OF THE INVENTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

In the figures, certain layers, components or features may be exaggerated for clarity, and broken lines illustrate optional features or operations unless specified otherwise. In addition, the sequence of operations (or steps) is not limited to the order presented in the claims or figures unless specifically indicated otherwise. Where used, the terms “attached”, “connected”, “contacting”, “coupling” and the like, can mean either directly or indirectly, unless stated otherwise.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present invention. In addition, as used herein, the singular forms “a”, “an” and “the” are intended to include the plural forms as well, unless the context clearly indicates otherwise.

It also will be understood that, as used herein, the term “comprising” or “comprises” is open-ended, and includes one or more stated elements, steps and/or functions without precluding one or more unstated elements, steps and/or functions. As used herein the term “and/or” includes any and all combinations of one or more of the associated listed items. It will also be understood that when an element is referred to as being “connected” to another element, it can be directly connected to the other element or intervening elements may be present. In contrast, when an element is referred to as being “directly connected” to another element, there are no intervening elements present. It will also be understood that the sizes and relative orientations of the illustrated elements are not shown to scale, and in some instances they have been exaggerated for purposes of explanation.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this application and the relevant art and should not be interpreted in an idealized or overly formal sense unless expressly so defined herein.

The term “electronic” means that the system, operation or device can communicate using any suitable electronic media and typically employs programmatically controlling the communication, interface protocol, timing and data exchange, and the like, between components of a digital camera with an auto-focus system. The term “automatic” means that substantially all or all of the operations so described can be carried out without requiring active manual input of a human operator, and typically means that the operation(s) can be programmatically electronically directed and/or carried out.

The term “active auto-focus” means an active type of auto-focusing that calculates a measure of the distance between the camera and the subject rather than analyzing relative sharpness by comparing multiple images. Active auto-focusing techniques typically employ systems including an auto-focusing beam emitter, such as an infrared emitter, and a sensor that detects beams reflected from a subject. For example, a triangulation auto-focus system can project an emitted ray(s) of radiation from a light source integral to the camera toward the target subject. The projected light spot or spots can be detected in a digital image (typically in relatively low resolution viewfinder image data) of the subject as reflected light. The term “spot” means a small, localized region zone of an image that is due to the captured emitted ray(s) of radiation from the projected light spot. The spot can be any suitable shape, including a strip or line, and can be sized to be detectable in the digital image using the resolution of the camera. In some embodiments, the spot can be between about 1-5 pixels, and in some particular embodiments, may be a sub-pixel size. In some embodiments the digital camera can be configured to generate multiple spots, one or more of which can be used to determine the proper focal distance for the target subject.

The term “passive auto-focus” means techniques that analyze relative sharpness by comparing multiple images. Passive auto-focusing techniques can include assessing the contrast of image content between images to provide a relative measure of sharpness.

Embodiments of the present invention can be used with any desired resolution (higher resolution providing more detail). A typical standard size/resolution for digital cameras, images (files), and displays is VGA (Video Graphics Array). VGA size is 640 pixels wide by 480 pixels tall (or vice-versa in portrait orientation). VGA has greater resolution than CIF, QCIF, and QVGA, but smaller than SVGA, XGA, and megapixel. In particular embodiments, such as for compact mobile phones, the digital cameras can be configured to provide QVGA (Quarter-VGA) having about 320 pixels by 240 pixels which is larger (higher resolution) than QCIF, but smaller than VGA. However, it should be understood that embodiments of the present invention are not limited to particular pixel sizes or resolution parameters.

As will be appreciated by one of skill in the art, embodiments of the invention may be embodied as a method, system, data processing system, or computer program product. Accordingly, the present invention may take the form of an entirely software embodiment or an embodiment combining software and hardware aspects, all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic or other electronic storage devices, including a client/server architecture.

Computer program code for carrying out operations of the present invention may be written in an object oriented programming language such as Java, Smalltalk or C++. However, the computer program code for carrying out operations of the present invention may also be written in conventional procedural programming languages, such as the “C” programming language or in a visually oriented programming environment, such as VisualBasic.

The invention is described in part below with reference to flowchart illustrations and/or block diagrams of methods, systems, computer program products and data and/or system architecture structures according to embodiments of the invention. It will be understood that each block of the illustrations, and/or combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory or storage that can direct a computer or other programmable data processing apparatus to function in a particular manner, such that the instructions stored in the computer-readable memory or storage produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

Embodiments according to the present invention are described with reference to block diagrams and/or operational illustrations of methods, mobile terminals, and computer program products. It is to be understood that each block of the block diagrams and/or operational illustrations, and combinations of blocks in the block diagrams and/or operational illustrations, can be implemented by radio frequency, analog and/or digital hardware, and/or computer program instructions. These computer program instructions may be provided to a processor circuit of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

As used herein, a “mobile terminal” includes, but is not limited to, a terminal that is configured to receive communication signals via a wireless interface from, for example, a cellular network, a Wide Area Network, wireless local area network (WLAN), a GPS system, a mobile gaming handset, a webcamera and/or another RF communication device. Example mobile terminals include, but are not limited to, a cellular mobile terminal; a GPS positioning receiver; an acceleration measurement device with a wireless receiver; a personal communication terminal that may combine a cellular mobile terminal with data processing, facsimile and data communications capabilities; a personal data assistance (PDA) that can include a wireless receiver, pager, Internet/intranet access, local area network interface, wide area network interface, Web browser, organizer, and/or calendar; and a mobile or fixed computer or other device that includes a wireless receiver.

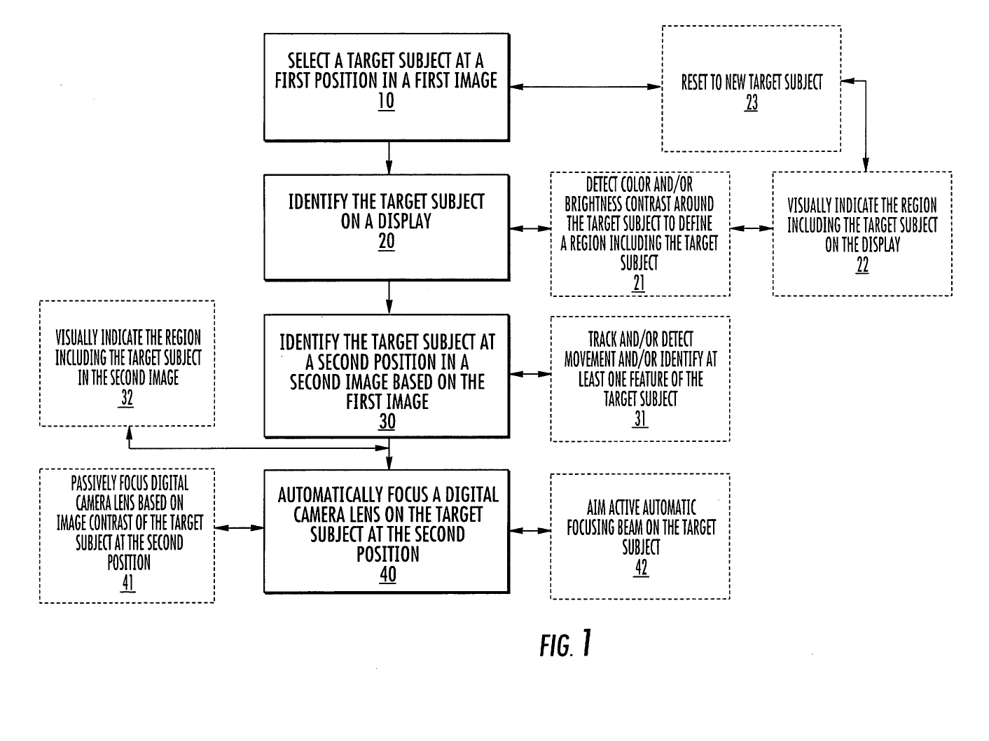

According to embodiments of the present invention shown in FIG. 1, a target subject is selected in a first position in a first image (block 10). The target subject can be identified on a display (block 20). The target subject can be identified in a second position and a second image (e.g., if the target subject moves with respect to the camera) based on the first image (block 30), and a digital camera lens can be automatically focused on the target subject at the second position (block 40). Therefore, the digital camera lens can be automatically focused on a target subject in the second position, which may be outside of the center region of a viewfinder or focus frame.

Accordingly, a region of interest may be identified and the focus (and/or any other relevant calibration, e.g., the camera aperture) of the camera can be directed to the region of interest. The region of interest can be visually indicated using a focus frame that “snaps” or fits relatively tightly around the region of interest. Video feed and/or image frames can be analyzed, e.g., using object and/or face recognition techniques to identify the region of interest and/or using analysis of brightness, color, contrast or object motion to identify the region of interest. In particular embodiments, the focus of the camera can “snap” from one region of interest to another so that a user can have real-time feedback regarding the region on which the camera is focused, e.g., between faces in a group picture.

For example, a target subject can be identified on the display by detecting color and/or brightness contrast around the target subject to define a region including the target subject (block 21). The region including the target subject can be visually indicated on the display (block 22). If the user wishes to select a different target subject in a focus frame, the user can reset to a new target subject (block 23).

For example, in particular embodiments, the user can select the target subject by positioning the target subject in the center of the focus frame and providing input to the camera indicating that the target subject is centered in focus frame, for example, by pressing a button. Typically, digital cameras include a two-stage shutter button such that when the user lightly presses the shutter button to the first stage, the digital camera auto-focusing system is initiated. When the shutter button is fully depressed, a picture is taken. In particular embodiments, the user can select a target subject by lightly pressing the shutter button to the first stage when the target subject is in the center of the focus frame. The target subject is identified on a display (block 20), and if the user wishes to reset to a different target subject (block 23), the user can reposition the different target subject in the center of the focus frame and lightly depress the shutter button.

Alternatively, the target subject can be selected by programmatically determining an object in the focus frame that is likely to be of interest to a user. For example, objects that are moving in the focus frame may be selected based on the detection of blurry and/or moving features in an image. As another example, the target subject can be selected using various techniques to recognize objects in an image, such as the face recognition techniques (e.g., including detecting the movement of a blinking eye in a human or animal face), object recognition techniques (e.g., pattern recognition techniques), and/or silhouette recognition techniques. Other object recognition techniques can be used. Object recognition techniques may be implemented using hardware and/or software.

In particular embodiments, a camera can include different modes of operation that are selectable by a user. For example, the user can select a “moving object mode” where the camera focuses on a moving object, or a “face recognition mode” where the camera focuses on a face in the image, or a “user selection mode” where the camera focuses on a defined region of the focus frame, such as the center region, and the user selects the target subject by positioning the target subject in a defined focusing region of the focus frame as discussed above. In some embodiment, the camera can automatically select a mode of operation based on the elements in the image.

When the target subject is in the second position in a second image, the subject can be identified by tracking movement of the subject between images and/or detecting movement (e.g., blurry features in an image) and/or identifying at least one feature of the target subject that is common to both the first and second images (block 31). In some embodiments, the region including the target subject in the second image may also be visually indicated on the display (block 32).

Various techniques can be used to automatically focus the digital camera lens on the target subject at the second position (block 40). For example, passive focusing techniques can be used based on the image contrast or sharpness of the target subject at the second position (block 41). In particular, the digital camera lens can be moved to different discrete focusing positions, each corresponding to a particular subject-to-camera distance. An image may be captured at each position and a relative sharpness value of the target subject can be determined for each image. The lens is then moved to the position that produced the image having the greatest sharpness value.

Active focusing techniques may also be used, e.g., by aiming an active automatic focusing beam, such as an infrared signal, in a direction towards the target subject (block 42). In particular, a direction of the target subject with respect to the camera can be determined, and an active auto-focusing beam can be aimed in the direction of the subject. A reflection of the auto-focusing beam from the target subject can be detected by sensor on the camera, and the distance between digital camera and the target subject can be determined, for example, based on the intensity of the reflected beam, the time the reflected beam is detected, and/or triangulation techniques. The camera lens is then moved to the focusing position corresponding to the distance of the target subject.

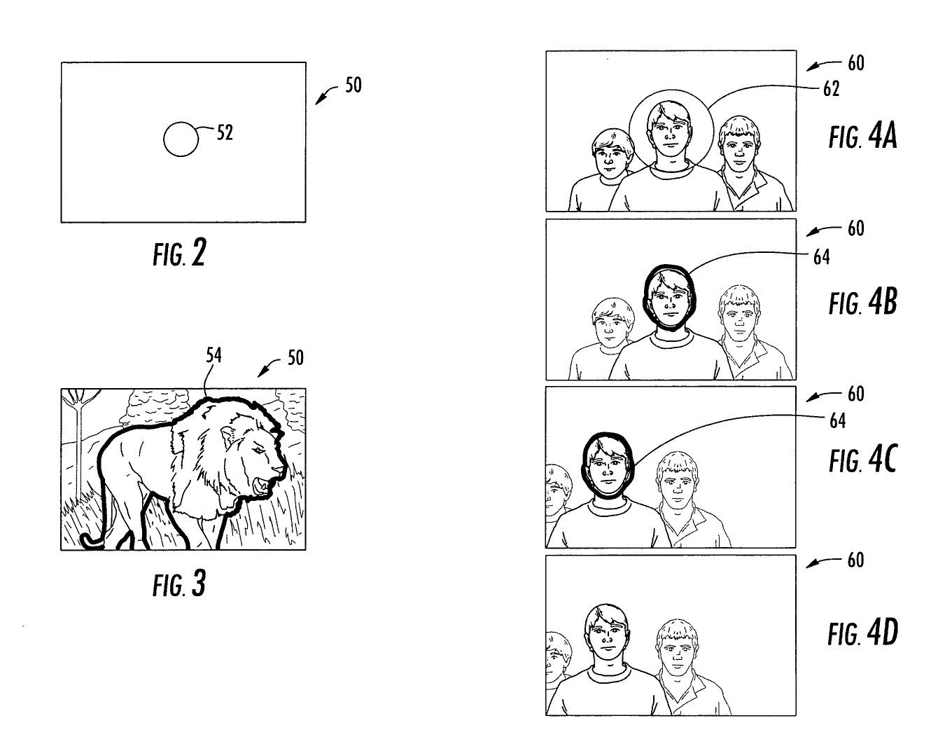

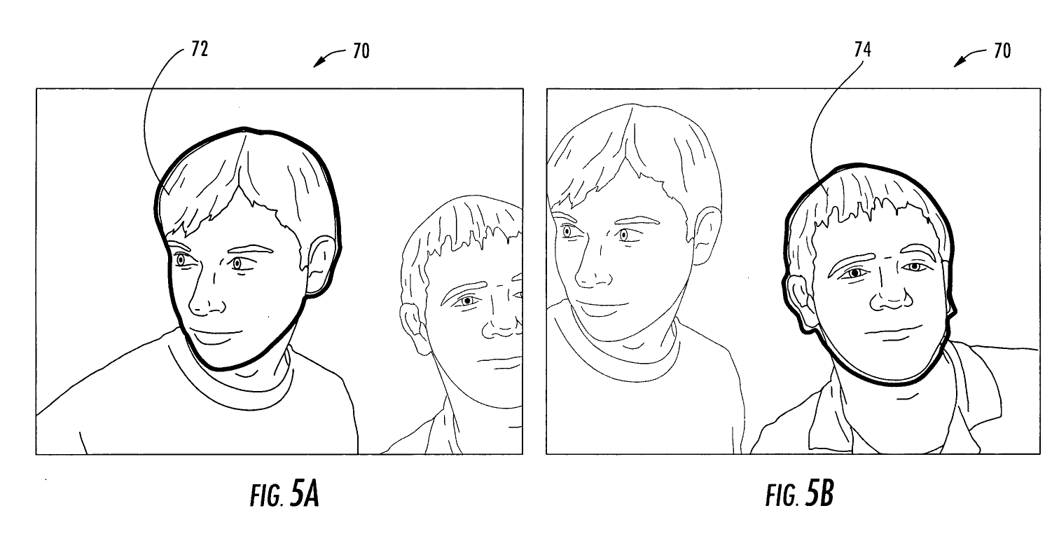

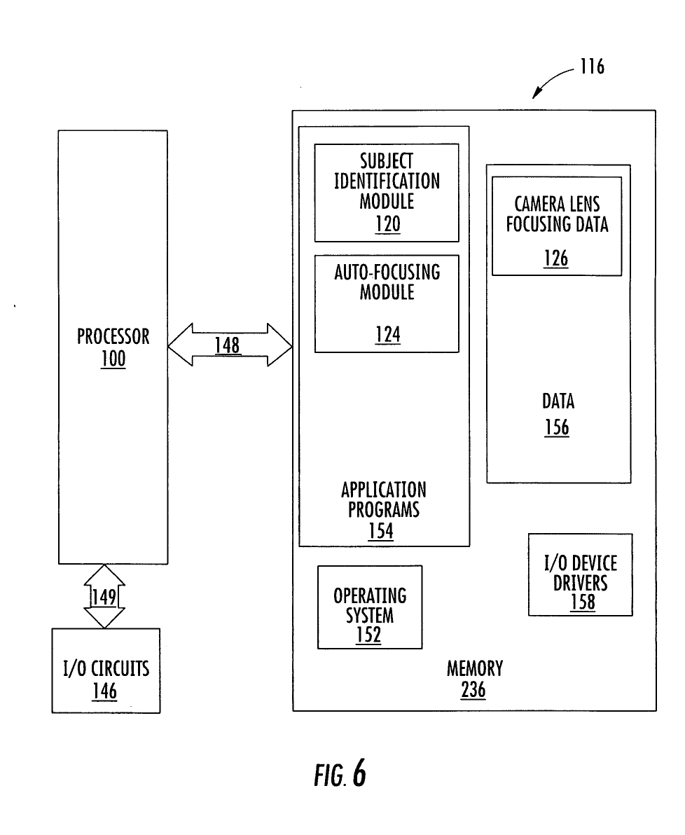

With reference to FIG. 2, a focus frame 50 including a focusing region 52 is shown. A target subject in the focusing region 52 can be selected using the techniques described above. For example, as shown in FIG. 3, a target subject 54 is visually indicated by outlining a region around the target subject 54. The target subject 54 shown in FIG. 4 is a lion; however, any target subject may be selected, visually indicated on a display and/or used for focusing purposes as described herein. The focus frame 50 can be a display on a digital camera, which in some embodiments, may be provided as part of a hand-held device, such as a cellular phone. If the target subject 54 moves, the focus follows a region in the image including the target subject 54 so that the target subject 54 remains in focus despite movement of the image and/or subject 54.

The target subject 54 is identified in FIG. 2 by outlining a region including the target subject on a display; however, the target subject can be identified using any suitable visual indication, such as highlighting with a color or brightness level on the display, such as a color covering the target subject or a semi-transparent color over the target subject. Various techniques can be used to define the region of the target subject 54 as discussed with respect to FIG. 1. For example, software can be used to detect the edge of the subject 54 using color and/or brightness contrast information in the image to identify the target subject 54 in FIG. 3.

As shown in FIG. 4A, a focus frame 60 including a center region 62 is shown. The target subject 64 (in this case, a man) is identified in FIG. 4B, for example, using edge detection and contrast information in the image or face recognition techniques. In another image shown in the focus frame 60 of FIG. 4C, the target subject 64 is in a different position on the focus frame 60 as compared with the image of FIG. 4B. The target subject 64 can be identified in the image of FIG. 4C, e.g., based on identifying at least one feature of the target subject 64 in the image of FIG. 4B or tracking or detecting movement of the target subject 64. When an image is captured in FIG. 4D, the digital camera lens is automatically focused on the target subject 64 even though the target subject 64 is no longer in the center region 62 (FIG. 4A).

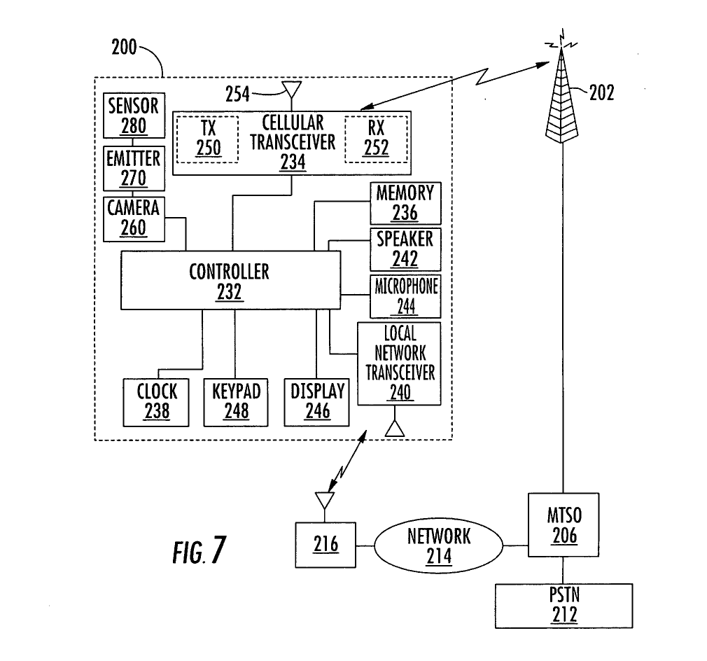

In particular embodiments, several objects can be identified and one (or more) of the objects can be identified for focusing purposes. In some embodiments, the user may reset the selection of a target subject in an image based on the visual indication of the target subject provided on the display. For example, as shown in the focus frame 70 in FIG. 5A, the face of a man or target subject 72 has been selected because the target subject 72 is in the center of the image. If the user decides to focus on another object in the image, the user can reset the target subject selection. For example, as shown in FIG. 5B, the user can move the focus frame 70 so that another face or target subject 74 is selected on the display. Accordingly, the display visually indicates the target subject for focusing purposes in real time so that the user is provided with continuous feedback on what the camera lens will focus on when photograph is taken. In some embodiments, the user can select one of the target subjects 72, 74 for focusing by touching the appropriate region of the image on a touch sensitive display. In further embodiments, one of the target subjects 72, 74 can be identified by a gaze direction, e.g., using eye-tracking/head-tracking techniques using the gaze direction and/or head direction of the camera user to identify one of the target subjects 72, 74. In still further embodiments, the software identifies two (or more) target subjects 72, 74, and the user can toggle between the target subjects 72, 74 to select the desired one of the subjects 72, 74.

FIG. 6 illustrates an exemplary data processing system that may be included in devices operating in accordance with some embodiments of the present invention. As illustrated in FIG. 6, a data processing system, which can be used to carry out or direct operations includes a processor 100, a memory 236 and input/output circuits 146. The data processing system may be incorporated in the digital camera and/or portable communication device, or the like. The processor 100 communicates with the memory 236 via an address/data bus 148 and communicates with the input/output circuits 146 via an address/data bus 149. The input/output circuits 146 can be used to transfer information between the memory (memory and/or storage media) 236 and another component. These components may be conventional components such as those used in many conventional data processing systems, and/or image processing components, lens positioner, and the like, which may be configured to operate as described herein.

In particular, the processor 100 can be commercially available or custom microprocessor, microcontroller, digital signal processor or the like. The memory 236 may include any memory devices and/or storage media containing the software and data used to implement the functionality circuits or modules used in accordance with embodiments of the present invention. The memory 236 can include, but is not limited to, the following types of devices: cache, ROM, PROM, EPROM, EEPROM, flash memory, SRAM, DRAM and magnetic disk. In some embodiments of the present invention, the memory 236 may be a content addressable memory (CAM).

As further illustrated in FIG. 6, the memory (and/or storage media) 236 may include several categories of software and data used in the data processing system: an operating system 152; application programs 154; input/output device drivers 158; and data 156. As will be appreciated by those of skill in the art, the operating system 152 may be any operating system suitable for use with a data processing system, such as IBM®, OS/2®, AIX® or zOS® operating systems or Microsoft® Windows®95, Windows98, Windows2000 or WindowsXP operating systems Unix or Linux™ or Symbian® OS. IBM, OS/2, AIX and zOS are trademarks of International Business Machines Corporation in the United States, other countries, or both while Linux is a trademark of Linus Torvalds in the United States, other countries, or both. Microsoft and Windows are trademarks of Microsoft Corporation in the United States, other countries, or both. The input/output device drivers 158 typically include software routines accessed through the operating system 152 by the application program 154 to communicate with devices such as the input/output circuits 146 and certain memory 236 components. The application programs 154 are illustrative of the programs that implement the various features of the circuits and modules according to some embodiments of the present invention. Finally, the data 156 represents the static and dynamic data used by the application programs 154 the operating system 152 the input/output device drivers 158 and other software programs that may reside in the memory 236.

The data processing system 116 may include several modules, including a target subject identification module 120, an auto-focus module 124, and the like. The modules may be configured as a single module or additional modules otherwise configured to implement the operations described herein. For example, the subject identification module 120 can be configured to select the target subject (e.g., as described with respect to blocks 10, 20, 21, 22, 23, 30, 31 and 32 in FIG. 1) and the auto-focusing module 124 can be configured to automatically focus the digital camera lens on the target subject (e.g., as described with respect to blocks 40, 41 and 42 of FIG. 1). The data 156 can include camera lens focusing data 126, which may include data concerning the relative position of the target subject, contrast data, image data, and the like.

In some embodiments, the target subject can be identified using various image recognition techniques. For example, “intelligent” object recognition can be used to identify an object of interest, e.g., using “computer vision”, feature extraction, edge detection, motion detection and/or facial recognition techniques. “Intelligent” object recognition techniques are described, for example, in M. Ekinci, E. Gedikli, “Silhouette Based Human Motion Detection and Analysis for Real-Time Automated Video Surveillance,” Turk J Elec Engin, Vol. 13, No. 2 (2005).

In some cases, the subject identification module 120 in FIG. 6 can distinguish between motion of the camera 260 (in which substantially the entire frame moves) and motion of the subject. In particular embodiments, a database of images can be used by the subject identification module 120 in FIG. 6 to recognize features and/or subjects that may be a target subject for focusing purposes in a new image. For example, a face that has been photographed by a user many times may be a desired target subject is a new image. If the subject identification module 120 recognizes a face from the database of images in a new image (e.g., using face recognition techniques), the subject identification module 120 can focus on the recognized face instead of a new face.

While the present invention is illustrated with reference to the application programs 120, 124 in FIG. 6, as will be appreciated by those of skill in the art, other configurations fall within the scope of the present invention. For example, rather than being an application program 154 these circuits and modules may also be incorporated into the operating system 152 or other such logical division of the data processing system. Furthermore, while the application programs 120, 124 in FIG. 6 are illustrated in a single data processing system, as will be appreciated by those of skill in the art, such functionality may be distributed across one or more data processing systems. Thus, the present invention should not be construed as limited to the configurations illustrated in FIG. 6, but may be provided by other arrangements and/or divisions of functions between data processing systems. For example, although FIG. 6 is illustrated as having various circuits and modules, one or more of these circuits or modules may be combined, or separated further, without departing from the scope of the present invention.

FIG. 7 is a schematic block diagram of a wireless communication system that includes a wireless terminal 200, such as a mobile wireless communications terminal, that receives wireless communication signals from a cellular base station 202 and/or a wireless local network 216. The cellular base station 202 is connected to a MTSO 206, which, in turn, is connected to a PSTN 212, and a network 214 (e.g., Internet). The mobile terminal 200 may communicate with the wireless local network 216 using a communication protocol that may include, but is not limited to, 802.11a, 802.11b, 802.11e, 802.11g, 802.11i, and/or other wireless local area network protocols. The wireless local network 216 may be connected to the network 214.

In some embodiments of the invention, the mobile terminal 200 includes a digital camera 260, focusing beam emitter 270, sensor 280, a controller 232, a cellular transceiver 234, a memory 236, a timing circuit (clock) 238, a local network transceiver 240, a speaker 242, a microphone 244, a display 246 and a keypad 248.

In particular, the controller 232 may be configured to control various functions of the wireless terminal 200, including focusing a lens of the camera 260 of the wireless terminal 200 as described herein and/or displaying and identifying a target subject on a display 246, e.g., based on instructions from the subject identification module 120 and/or auto-focusing module 124 of the memory 236 (FIG. 6).

In particular embodiments using active focusing techniques, the focusing beam emitter 270 is configured to emit an automatic focusing beam, such as an infrared beam, on a target subject. The sensor 280 is configured to sense a reflection of the focusing beam from the target subject to determine a distance between the camera 260 and the target subject. The focusing beam emitter 270 and/or sensor 280 can be moved by the controller based on the direction of the target subject to aim the beam in the direction of the target subject.

The memory 236 stores software that is executed by the controller 232, and may include one or more erasable programmable read-only memories (EPROM or Flash EPROM), battery backed random access memory (RAM), magnetic, optical, or other digital storage device, and may be separate from, or at least partially within, the controller 232. The controller 232 may include more than one processor, such as, for example, a general purpose processor and a digital signal processor, which may be enclosed in a common package or separate and apart from one another.

As shown in FIG. 7, the cellular transceiver 234 typically includes both a transmitter (TX) 250 and a receiver (RX) 252 to allow two-way communications, but the present invention is not limited to such devices and, as used herein, a “transceiver” may include only the receiver 252. The mobile terminal 200 may thereby communicate with the base station 202 using radio frequency signals, which may be communicated through an antenna 254. For example, the mobile terminal 200 may be configured to communicate via the cellular transceiver 234 using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). Communication protocols as used herein may specify the information communicated, the timing, the frequency, the modulation, and/or the operations for setting-up and/or maintaining a communication connection. In some embodiments, the antennas 228 and 254 may be a single antenna.

In some embodiments, various operations described herein (for example, as described with respect to the subject identification module 120 and the auto-focusing module 124) can be performed by the mobile device 200. However, it should be readily apparent to one of skill in the art that various operations may also be performed by other elements of the network 214, such as a server. For example, a server or other processor in the network 214 may include more memory and/or processor capabilities than the mobile device 200. Therefore, it may be advantageous to have some of the operations according to embodiments of the present invention carried out on a processor (e.g., a server) in the network 214 and various results or instructions sent via the network 214 to the mobile device 200. For example, video feed can be analyzed on a processor or server in the network 214 and/or the target subject can be identified by the processor or server using the operations described herein.

The foregoing is illustrative of the present invention and is not to be construed as limiting thereof. Although a few exemplary embodiments of this invention have been described, those skilled in the art can readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A method of identifying a target subject for auto-focusing a digital camera, the method comprising:
selecting a target subject at a first position in a first image;
identifying the target subject on a display;
identifying the target subject at a second position in a second image based on the first image; and
automatically focusing a digital camera lens on the target subject at the second position.

2. The method of claim 1, wherein identifying the target subject on the display includes detecting color and/or brightness contrast around the target subject to define a region including the target subject.

3. The method of claim 2, wherein identifying the target subject on the display includes visually indicating the region including the target subject on the display.

4. The method of claim 1, wherein identifying the target subject at a second position in a second image based on the first image includes tracking movement of the target subject between the first and second positions.

5. The method of claim 1, wherein identifying the target subject at a second position in a second image based on the first image includes identifying at least one feature of the target subject in the second image based on the first image.

6. The method of claim 1, further comprising visually indicating a region including the target subject in the second image on the display.

7. The method of claim 1, wherein automatically focusing a digital camera lens on the target subject at the second position includes passively focusing the digital camera lens based on image sharpness of a region including the target subject at the second position using at least two different focusing positions of the digital camera lens.

8. The method of claim 1, wherein automatically focusing a digital camera lens on the target subject at the second position includes actively automatically focusing a region in the second image that includes the target subject.

9. The method of claim 8, wherein actively automatically focusing a region in the second image that includes the target subject comprises determining a direction of the target subject with respect to the digital camera, and aiming an active automatic focusing beam in the direction of the target subject.

10. The method of claim 9, further comprising detecting a reflection of the automatic focusing beam from the target subject and determining a distance between the digital camera and the target subject.

11. The method of claim 9, wherein the active automatic focusing beam is infrared signal.

12. The method of claim 1, further comprising resetting the selection of the target subject to a different target subject.

13. The method of claim 1, further comprising identifying the target subject based on an object and/or face recognition technique.

14. An electronic device including a digital camera, the digital camera comprising:
a subject identification module configured to select a target subject at a first position in a first image, to identify the target subject on a display, and to identify the target subject at a second position in a second image based on the first image; and
an auto-focusing module configured to automatically focus a digital camera lens on the target subject at the second position.

15. The device of claim 14, wherein the subject identification module is configured to identify the target subject on the display by detecting color and/or brightness contrast around the target subject to define a region including the target subject.

16. The device of claim 15, wherein the subject identification module is configured to identify the target subject on the display by visually indicating the region including the target subject on the display.

17. The device of claim 14, wherein the subject identification module is configured to identify the target subject at a second position in a second image based on the first image by tracking movement of the target subject between the first and second positions.

18. The device of claim 14, wherein the subject identification module is configured to identify the target subject at a second position in a second image based on the first image by identifying at least one feature of the target subject in the second image based on the first image.

19. The device of claim 14, wherein the subject identification module is configured to visually indicate a region including the target subject in the second image on the display.

20. The device of claim 14, wherein the auto-focusing module is configured to automatically focus a digital camera lens on the target subject at the second position by passively focusing the digital camera lens based on image sharpness of a region including the target subject at the second position using at least two different focusing positions of the digital camera lens.

21. The device of claim 14, wherein the auto-focusing module is configured to automatically focus a digital camera lens on the target subject at the second position by actively automatically focusing a region in the second image that includes the target subject.

22. The device of claim 21, wherein the auto-focusing module is configured to actively automatically focus a region in the second image that includes the target subject by determining a direction of the target subject with respect to the digital camera, and aiming an active automatic focusing beam in the direction of the target subject.

23. The device of claim 22, wherein the auto-focusing module is configured to automatically focus a digital camera lens on the target subject at the second position by detecting a reflection of the automatic focusing beam from the target subject and determining a distance between the digital camera and the target subject.

24. The device of claim 23, wherein the active automatic focusing beam is infrared signal.

25. The device of claim 14, wherein the subject identification module is configured reset the selection of the target subject to a different target subject.

26. The device of claim 14, wherein the subject identification module is further configured to identify the target subject based on an object and/or face recognition technique.

27. A computer program product for identifying a target subject for auto-focusing a digital camera, the computer program product comprising:
a computer readable storage medium having computer readable program code embodied in said medium, said computer-readable program code comprising:
computer readable program code that selects a target subject at a first position in a first image;
computer readable program code that identifies the target subject on a display;
computer readable program code that identifies the target subject at a second position in a second image based on the first image; and
computer readable program code that automatically focuses a digital camera lens on the target subject at the second position.
